(19) United States
(12) Patent Application Publication
(10) Pub. No.: US 2025/0313080 A1
(43) Pub. Date: Oct. 9, 2025

(54) ELECTRIC DRIVE MOTOR AND INVERTER ON A POWER MACHINE

(71) Applicant: Doosan Bobcat North America Inc., West Fargo, ND (US)

(72) Inventors: Jeffrey A. Dahl, Bismarck, ND (US); Jonathan Joseph Roehrl, Bismarck, ND (US); Kenneth L. Dieter, Danvers, MN (US)

(21) Appl. No.: 19/169,624

(22) Filed: Apr. 3, 2025

Related U.S. Application Data
(60) Provisional application No. 63/575,801, filed on Apr. 7, 2024.

(51) Int. Cl. B60K 7/00; B60L 15/00; B60L 50/60; E02F 3/28; E02F 3/32; E02F 9/02; E02F 9/08; H02K 5/04; H02K 11/00; H02K 11/33

(52) U.S. Cl. CPC B60K 7/0007; B60L 15/007; B60L 50/60; E02F 3/283; E02F 3/325; E02F 9/02; E02F 9/0841; H02K 5/04; H02K 11/0094; H02K 11/33; B60K 2007/0092; B60L 2200/40

(57) ABSTRACT

A power machine includes a first frame member, a second frame member including at least one tractive element, at least one electric drive motor configured to propel the at least one tractive element and at least one inverter located in proximity to and coupled to the at least one electric drive motor. A rotatable joint rotatably couples the first frame member to the second frame member. The at least one battery is located on the first frame member and is configured to power the at least one electric drive motor on the second frame member by supplying current through an electrical connection that is routed across the rotatable joint to couple to the at least one inverter.

### CROSS-REFERENCE TO RELATED APPLICATION

This application claims the benefit of priority from U.S. Provisional Patent Application Ser. No. 63/575,801 filed on Apr. 7, 2024 for “Electric Drive Motor and Inverter on a Power Machine;” the priority application is hereby incorporated by reference in its entirety.

### BACKGROUND

This disclosure is directed toward power machines. More particularly, this disclosure is directed to an electric drive motor and inverter on a power machine.

Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders, excavators, utility vehicles, tractors, and trenchers, to name a few examples.

The discussion above is merely provided for general background information and is not intended to be used as an aid in determining the scope of the claimed subject matter.

### SUMMARY

A power machine includes a first frame member, a second frame member, a rotatable joint that rotatably couples the first frame member to the second frame member and at least one battery located on the first frame member. The second frame member includes at least one tractive element, at least one electric drive motor configured to propel the at least one tractive element and at least one inverter located in proximity to and coupled to the at least one electric drive motor. The at least one battery is located on the first frame member and is configured to power the at least one electric drive motor on the second frame member by supplying current across an electrical connection that is routed through the rotatable joint to couple to the at least one inverter.

A power machine includes a front frame member, a rear frame member, an articulation joint that rotatably couples the front frame member to the rear frame member and at least one battery located on the rear frame member. The front frame member includes at least one front tractive element, at least one front electric drive motor configured to propel the at least one front tractive element and at least one front inverter located in proximity to and coupled to the at least one front electric drive motor. The rear frame member includes at least one rear tractive element, at least one rear electric drive motor configured to propel the at least one rear tractive element and at least one rear inverter located in proximity to and coupled to the at least one rear electric drive motor. The at least one battery is located on the rear frame member and is coupled to the at least one front inverter by supplying power along an electrical connection that is routed through the articulation joint to couple to the at least one front inverter.

A power machine includes an undercarriage and a house rotatably coupled to the undercarriage at a swivel joint, a first tractive element coupled to a left side of the undercarriage, a second tractive element coupled to a right side of the undercarriage and at least one battery located on the house. The first tractive element has a first electric drive motor and a first inverter located in proximity to and coupled to the first electric drive motor. The first electric drive motor is configured to propel the first tractive element. The second tractive element has a second electric drive motor and a second inverter located in proximity to and coupled to the second electric drive motor. The second electric drive motor is configured to propel the second tractive element. The at least one battery is coupled to the first inverter and the second inverter by supplying power through an electrical connection that is routed through the swivel joint.

This Summary and the Abstract are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which embodiments of the present disclosure may be advantageously practiced.

FIG. 2 is a perspective view showing generally a front of a power machine in the form of an articulated loader on which embodiments disclosed may be advantageously practiced.

FIG. 3 is a perspective view showing generally a back of the articulated loader shown in FIG. 2.

FIG. 4 is a perspective view of an all-electric power machine in the form of an all-electric articulated loader under an embodiment.

FIG. 5A illustrates a diagrammatic top view of the all-electric articulated loader illustrated in FIG. 4.

FIG. 5B is a perspective view of frame and wheel components for an articulated loader.

FIG. 5C is an exploded view of components of an exemplary electric wheel assembly.

FIG. 5D shows the components of FIG. 5C assembled together in an exemplary embodiment.

FIG. 6 is a perspective view showing generally a back of a power machine in the form of an excavator on which embodiments disclosed may be advantageously practiced.

FIG. 7 illustrates a diagrammatic side view of an all-electric power machine in the form of an all-electric excavator under an embodiment.

FIG. 8 illustrates a diagrammatic top view of the all-electric excavator illustrated in FIG. 7.

FIG. 9 is a perspective view showing generally a front of a power machine in the form of a skid-steer loader on which embodiments disclosed may be advantageously practiced.

FIG. 10 is a diagrammatic side view of a power machine lift arm and implement carrier which support power transfer system components providing power to an attached implement according to an embodiment.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Disclosed embodiments include an all-electric tractive drive system for a power machine. The drive system includes independent electric motors which drive each tractive element via a planetary gearbox. In all-electric power machines, inverters that convert current from DC to AC are generally positioned in proximity to the battery or battery management system, which are located in a portion of the vehicle that is generally the compartment or space that formerly occupied the combustion engine. Since many wires are needed to supply AC from the inverter to a distal electric drive motor that has, for example, multiple stator phases, there is a challenge of routing and protecting the many wires especially when the routing of wires needs to go across, along and/or through a rotatable joint, such as an articulating joint. To route a minimum number of wires across, along and/or through these types of joints, the disclosed embodiments locate an inverter in proximity to each of the electric drive motors. Therefore, a minimum number of wires running DC are needed to route across, along and/or through the joints to power the electric drive motors.

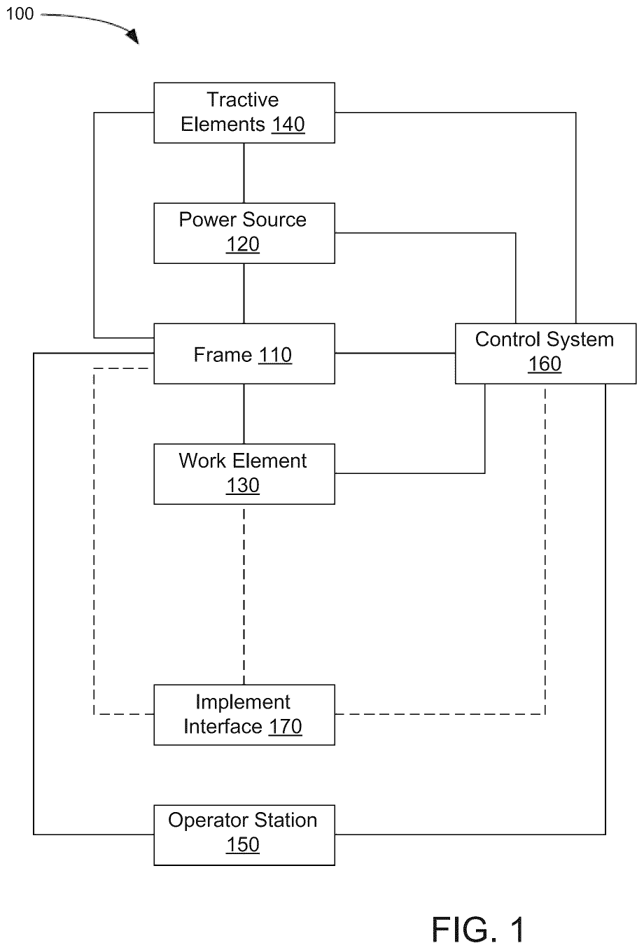

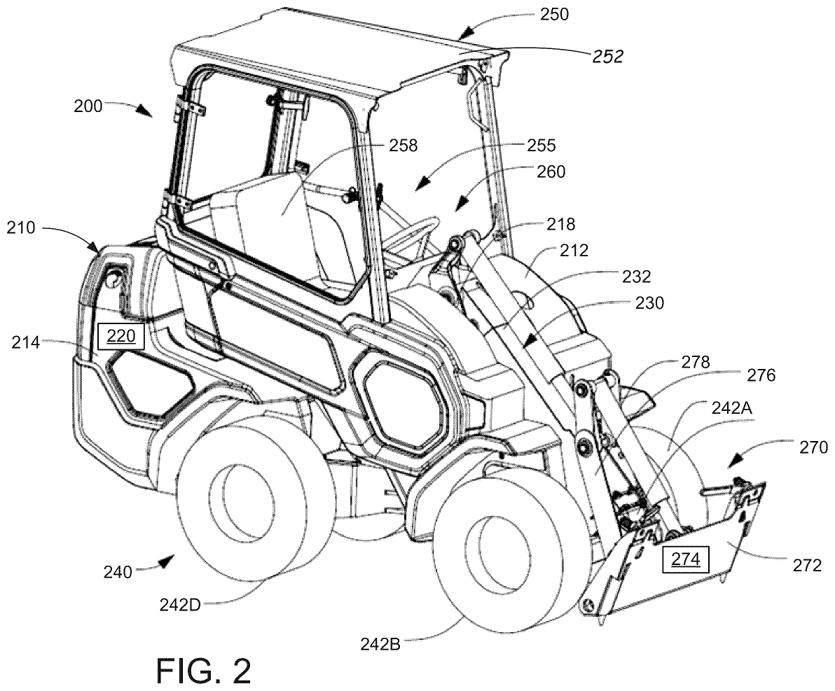

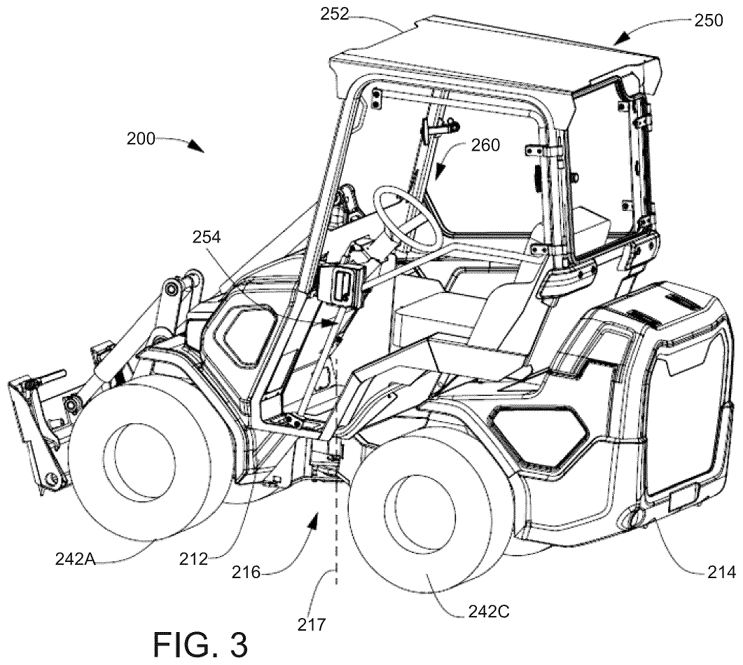

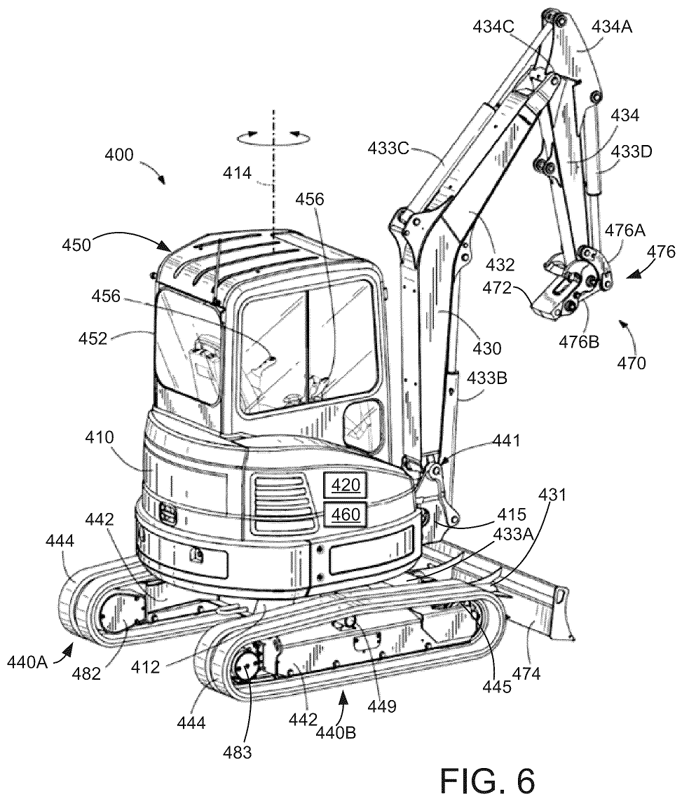

These concepts can be practiced on various power machines, as will be described below. A representative power machine on which the embodiments can be practiced is illustrated in diagram form in FIG. 1, one example of such a power machine is illustrated in FIGS. 2-3 and another example of such a power machine is illustrated in FIG. 6. For the sake of brevity, only these power machines are discussed. However, as mentioned above, the embodiments below can be practiced on any of a number of power machines, including power machines of different types from the representative power machine shown in FIGS. 2-3 and FIG. 6. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power.

FIG. 1 is a block diagram illustrating the basic systems of a power machine 100 upon which the embodiments discussed below can be advantageously incorporated and can be any of a number of different types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that can perform a dedicated task. For example, some work vehicles have a lift arm to which an implement such as a bucket is attached such as by a pinning arrangement. The work element, i.e., the lift arm can be manipulated to position the implement to perform the task. In some instances, the implement can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, the implement carrier is fixed to the implement (i.e. not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work elements with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. Frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which can provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements to perform a work function. Power sources for power machines may include an engine, such as an internal combustion engine, and a power conversion system, such as a mechanical transmission or a hydraulic system that is capable of converting the output from an engine into a form of power that is usable by a work element, or other types of power sources including electrical sources provided by, for example, batteries, or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments, operator positions or neither, may be capable of being operated remotely (i.e. from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e. remote from both the power machine and any implement to which is it coupled) that is capable of controlling at least some of the operator-controlled functions on the power machine.

FIGS. 2-3 illustrate a loader 200, which is one example of a power machine of the type illustrated in FIG. 1 where the embodiments discussed below can be advantageously employed. Loader 200 is an articulated loader with a front mounted lift arm assembly 230, which in this example is a telescopic lift arm. Loader 200 is one example of power machine 100 illustrated broadly in FIG. 1 and discussed above. To that end, features of loader 200 described below include reference numbers that are generally similar to those used in FIG. 1. For example, loader 200 is described as having a frame 210, just as power machine 100 has a frame 110. The description herein of loader 200 with references to FIGS. 2-3 provides an illustration of the environment in which the embodiments discussed below and this description should not be considered limiting especially as to the description of features that loader 200 that are not essential to the disclosed embodiments. Such features may or may not be included in power machines other than loader 200 upon which the embodiments disclosed below may be advantageously practiced. Unless specifically noted otherwise, embodiments disclosed below can be practiced on a variety of power machines, with the loader 200 being only one of those power machines. For example, some or all of the concepts discussed below can be practiced on many other types of work vehicles such as various other loaders, excavators, trenchers, and dozers, to name but a few examples.

Loader 200 includes frame 210 that supports a power system 220 that can generate or otherwise provide power for operating various functions on the power machine. For example, power system 220 may provide electrical power for operating various functions on the power machine. Frame 210 also supports a work element in the form of lift arm assembly 230 that is powered by the power system 220 and that can perform various work tasks. As loader 200 is a work vehicle, frame 210 also supports a traction system 240, which is also powered by power system 220 and can propel the power machine over a support surface. The lift arm assembly 230 in turn supports an implement interface 270 that includes an implement carrier 272 that can receive and secure various implements to the loader 200 for performing various work tasks and power couplers 274, to which an implement can be coupled for selectively providing power to an implement that might be connected to the loader. Power couplers 274 can provide sources of hydraulic or electric power or both. The loader 200 includes a cab 250 that defines an operator station 255 from which an operator can manipulate various control devices to cause the power machine to perform various work functions. Cab 250 includes a canopy 252 that provides a roof for the operator compartment and is configured to have an entry 254 (for example, the left side as illustrated in FIG. 3) on one side of the seat to allow for an operator to enter and exit the cab. Although cab 250 as shown does not include any windows or doors, a door or windows can be provided.

The operator station 255 includes an operator seat 258 and the various operation input devices 260, including control levers that an operator can manipulate to control various machine functions. Operator input devices can include a steering wheel, buttons, switches, levers, sliders, pedals and the like that can be stand-alone devices such as hand operated levers or foot pedals or incorporated into hand grips or display panels, including programmable input devices. Actuation of operator input devices can generate signals in the form of electrical signals, hydraulic signals, and/or mechanical signals. Signals generated in response to operator input devices are provided to various components on the power machine for controlling various functions on the power machine. Among the functions that are controlled via operator input devices on power machine 100 include control of the tractive system 240, the lift arm assembly 230, the implement carrier 272, and providing signals to any implement that may be operably coupled to the implement.

Loaders can include human-machine interfaces including display devices that are provided in the cab 250 to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assist an operator with operation of the power machine or an implement coupled to the power machine. Other information that may be useful for an operator can also be provided. Other power machines, such walk behind loaders may not have a cab nor an operator compartment, nor a seat. The operator position on such loaders is generally defined relative to a position where an operator is best suited to manipulate operator input devices.

Various power machines that can include and/or interact with the embodiments discussed below can have various frame components that support various work elements. The elements of frame 210 discussed herein are provided for illustrative purposes and should not be considered the only type of frame that a power machine on which the embodiments can be practiced can employ. As mentioned above, loader 200 is an articulated loader and as such has two frame members that are pivotally coupled together at an articulation joint. For the purposes of this document, frame 210 refers to the entire frame of the loader. Frame 210 of loader 200 includes a first or rear frame member 214 and a second or front frame member 212. The second or front and first or rear frame members 212, 214 are coupled together at an articulation joint 216 (FIG. 3). Actuators (not shown) are provided to rotate the second or front and first or rear frame members 212, 214 relative to each other about an axis 217 (FIG. 3) to accomplish a turn.

The front frame member 212 supports and is operably coupled to the lift arm 230 at joint 216. A lift arm actuator (not shown, positioned beneath the lift arm 230) is coupled to the front frame member 212 and the lift arm 230 and is operable to raise and lower the lift arm under power. The front frame member 212 also supports at least two front tractive elements or wheels 242A and 242B. Front tractive elements or wheels 242A and 242B are mounted to rigid axles (the axles do not pivot with respect to the front frame member 212). The cab 250 is also supported by the front frame member 212 so that when the front frame member 212 articulates with respect to the rear frame member 214, the cab 250 moves with the front frame member 212 so that it will swing out to either side relative to the rear frame member 214, depending on which way the loader 200 is being steered.

The rear frame member 214 supports various components of the power system 220. In addition, one or more hydraulic pumps may be coupled to an engine and supported by the rear frame member 214. The hydraulic pumps are part of a power conversion system to convert power from the power system 220 into a form that can be used by actuators (such as cylinders and drive motors) on the loader 200. Power system 220 is discussed in more detail below. In addition, at least two rear tractive elements or wheels 242C and 242D are mounted to rigid axles that are in turn mounted to the rear frame member 214. When the loader 200 is pointed in a straight direction (i.e., the front frame portion 212 is aligned with the rear frame portion 214), a portion of the cab is positioned over the rear frame portion 214.

The lift arm assembly 230 shown in FIGS. 2-3 is one example of many different types of lift arm assemblies that can be attached to a power machine such as loader 200 or other power machines on which embodiments of the present discussion can be practiced. The lift arm assembly 230 is a radial lift arm assembly, in that the lift arm is mounted to the frame 210 at one end of the lift arm assembly and pivots about the mounting joint 216 as it is raised and lowered. The lift arm assembly 230 may be a telescoping lift arm. The lift arm assembly includes a boom 232 that is pivotally mounted to the front frame member 212 at joint 216. A telescoping member may be slidably inserted into boom 232; a telescoping cylinder (not shown) is coupled to the boom and the telescoping member and is operable to extend and retract the telescoping member under power. An implement carrier mounting structure 276 is mounted to the telescoping member. The implement carrier 272 and the power couplers 274 are mounted to the positioning structure. A tilt actuator 278 is pivotally mounted to both the implement carrier mounting structure 276 and the implement carrier 272 and is operable to rotate the implement carrier with respect to the implement carrier mounting structure under power. Among the operator controls 260 in the operator compartment 255 are operator controls to allow an operator to control the lift, telescoping, and tilt functions of the lift arm assembly 230.

Other lift arm assemblies can have different geometries and can be coupled to the frame of a loader in various ways to provide lift paths that differ from the radial path of lift arm assembly 230. For example, some lift paths on other loaders provide a radial lift path. Others have multiple lift arms coupled together to operate as a lift arm assembly. Still other lift arm assemblies do not have a telescoping member. Others have multiple segments. Unless specifically stated otherwise, none of the inventive concepts set forth in this discussion are limited by the type or number of lift arm assemblies that are coupled to a particular power machine.

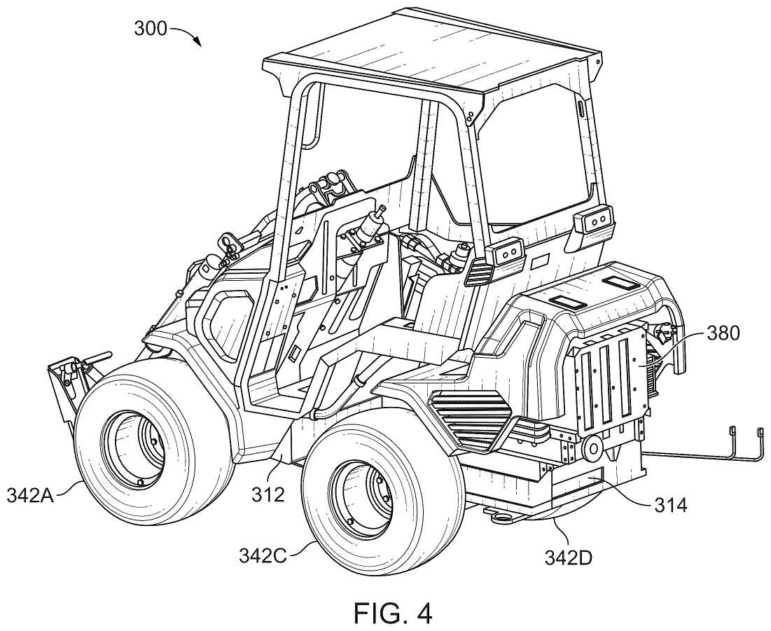

FIG. 4 is a perspective view of an all-electric power machine 300 in the form of an all-electric articulated loader in accordance with an embodiment. All-electric articulated loader 300 includes features described above in regards to power machine 200 with power sources including, for example, a battery or battery pack. In particular, loader 300 includes a battery or battery pack 380, which is part of a battery system that is supported by first or rear frame member 314. Frame 310 also includes front frame member 312.

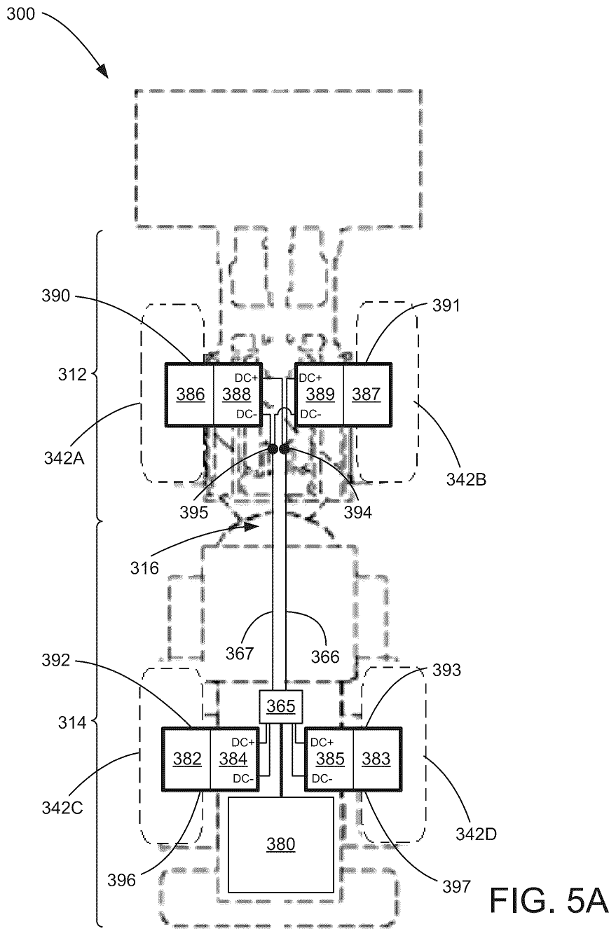

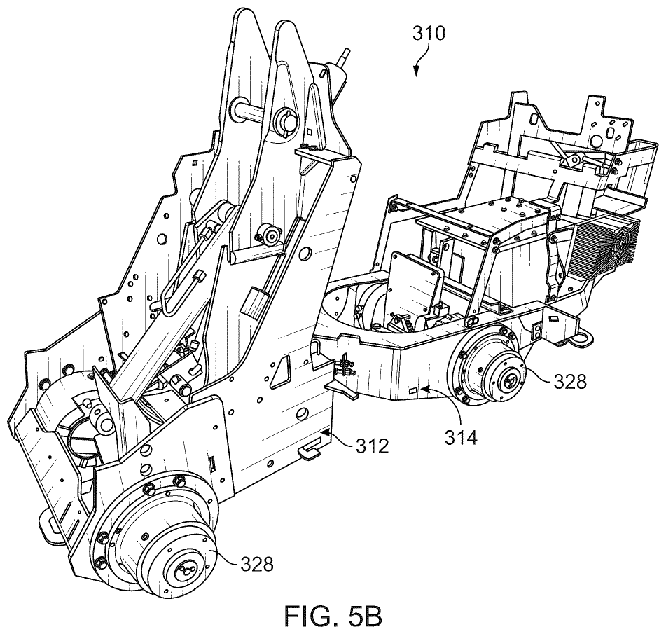

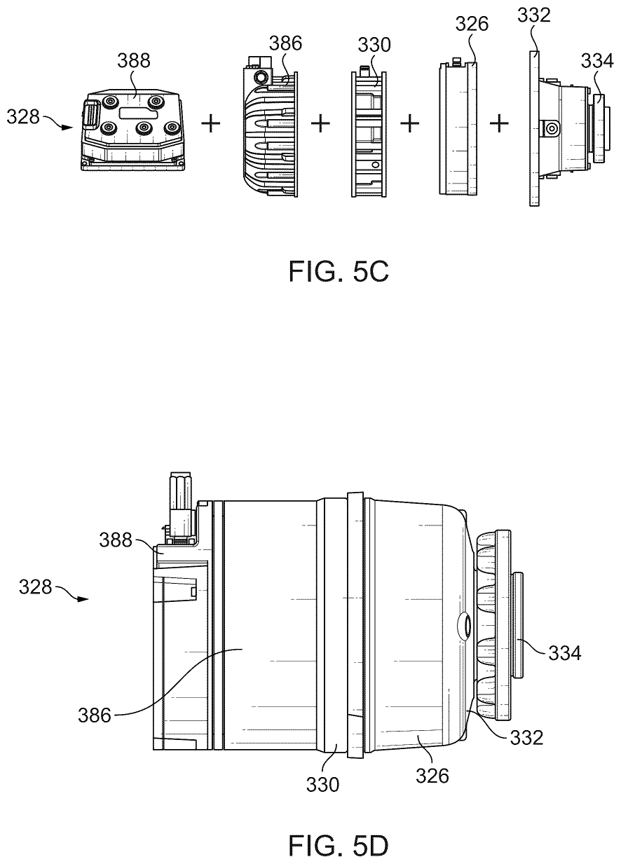

FIG. 5A illustrates a diagrammatic top view of all-electric articulated loader 300 in FIG. 4. As illustrated, battery or battery pack 380 is located on and supported by first or rear frame member 314. Rear frame member 314 also includes at least one rear tractive element, with FIGS. 4 and 5A illustrating a first rear tractive element 342C and a second rear tractive element 342D. Rear frame member 314 includes at least one rear electric drive motor, with FIGS. 4 and 5A illustrating a first rear electric drive motor 382 configured to propel tractive element 342C and a second rear electric drive motor 383 configured to propel tractive element 342D. Rear frame member 314 also includes at least one rear inverter, with FIGS. 4 and 5A illustrating a first rear inverter 384 located in proximity to and coupled to first rear electric drive motor 382 and a second rear inverter 385 located in proximity to and coupled to second rear electric drive motor 383. In an exemplary embodiment, the at least one rear electric drive motor and the at least one rear inverter may be packaged together; for example, FIGS. 4 and 5A illustrate a first rear electric drive motor 382 and first rear inverter 384 packaged together in a first rear motor package 392 and second rear electric drive motor 383 and second rear inverter 385 packaged together in a second rear motor package 393.

Second or front frame member 312 includes at least one front tractive element, with FIGS. 4 and 5A illustrating a first front tractive element 342A and a second front tractive element 342B. Front frame member 312 includes at least one front electric drive motor, with FIGS. 4 and 5A illustrating a first front electric drive motor 386 configured to propel tractive element 342A and a second front electric drive motor 387 configured to propel tractive element 342B. Front frame member 312 includes at least one front inverter, with FIGS. 4 and 5A illustrating a first front inverter 388 located in proximity to and at least electrically coupled to first front electric drive motor 386 and a second front inverter 389 located in proximity to and coupled to second front electric drive motor 387. In an exemplary embodiment, the at least one front electric drive motor and the at least one front inverter may be packaged together; for example, FIGS. 4 and 5A illustrate first front electric drive motor 386 and first front inverter 388 packaged together in a first front motor package 390 and second front electric drive motor 387 and second front inverter 389 packaged together in a second front motor package 391.

FIG. 5B is a front left perspective view of frame 310 with exemplary wheel assemblies 328 that can be used at each of the front and rear tractive elements 342. In an exemplary embodiment, a fully integrated electric wheel assembly 328 is provided for mounting respective wheels 342. However, it is to be understood that the disclosed concepts can be practiced on any articulated power machine to provide wheels that can be independently controlled and driven, and which can receive motive power from any power source. FIG. 5C is an exploded view of the components of an exemplary electric wheel assembly 328. FIG. 5D shows those components assembled together in an exemplary embodiment. In the illustrated embodiments, an exemplary electric wheel assembly 328 includes inverter 388, electric drive motor 386, brake 330, gear system 326, which can be a two stage planetary gear with mechanical free-wheeling capabilities for example, bearing 332 and wheel support flange 334.

An exemplary all-electric articulated loader 300 further includes a DC distributor 365 that may be located on first or rear frame member 314 that is configured to route DC power from battery pack 380 to each of the front inverters 388 and 389 and rear inverters 384 and 385. In particular, DC distributor 365 is configured to route an electrical connection across and/or along articulation joint 316 to couple to first front and second front inverters 388 and 389 or first front motor package 390 and second front motor package 391. An electrical connection may be a pair of high voltage pathways or wires 366 and 367. Under an embodiment, one of the pair of high voltage pathways or wires 366 couples to a first tee connection 394 on front frame member 312 and the other of the pair of front high voltage pathways or wires 367 couples to a second tee connection 395 on front frame member 312. At first tee connection 394, high voltage pathway or wire 366 splits and couples to a DC+ terminal on first front inverter 388 or first front motor package 390 and couples to a DC+ terminal on second front inverter 389 or second front motor package 391. At second tee connection 395, high voltage pathway or wire 367 splits and couples to a DC− terminal on first front inverter 388 or first front motor package 390 and couples to a DC− terminal on second front inverter 389 or second front motor package 391. DC distributor 365 is further configured to provide or supply power to first rear inverter 384 or first rear motor package 392 and second rear inverter 385 or second rear motor package 393.

In some specific embodiments, the motor package 590/591 may further integrate a drive train such as a planetary gear reduction to reduce the RPM between the motor and the track drive sprocket as shown in FIGS. 6-8, which will be discussed in more detail below.

FIG. 6 is a perspective view showing generally a back of a power machine in the form of an excavator 400 and of the type illustrated in FIG. 1, on which embodiments disclosed may be advantageously practiced. As noted above, disclosed embodiments may be practiced on a variety of power machines, with excavator 400 being only one of those types of power machines. Excavator 400 is described below for illustrative purposes. Not every excavator or power machine on which the illustrative embodiments may be practiced need have all of the features or be limited to the features that excavator 400 has. Excavator 400 has a first or house or upper frame member 410 that is pivotally mounted on a second or undercarriage or lower frame member 412 via a swivel joint. First or upper frame member 410 supports and encloses a power system 420 (represented in FIG. 6 as a block, as the actual power system is enclosed within the first or upper frame 410). The power system 420 may include an engine or battery pack that provides a power output to, for example, a hydraulic system. The hydraulic system may act as a power conversion system that includes one or more hydraulic pumps for selectively providing pressurized hydraulic fluid to actuators that are operably coupled to work elements in response to signals provided by operator input devices. The hydraulic system also includes a control valve system that selectively provides pressurized hydraulic fluid to actuators in response to signals provided by operator input devices. The excavator 400 includes a plurality of work elements in the form of a first lift arm structure 430 and a second lift arm structure 431 (not all excavators have a second lift arm structure). In addition, excavator 400, being a work vehicle, includes a pair of tractive elements in the form of left and right track assemblies 440A and 440B, which are disposed on opposing sides of lower frame 412.

An operator compartment 450 is defined in part by a cab 452, which is mounted on the first or upper frame 410. The cab 452 shown on excavator 400 is an enclosed structure, but other operator compartments need not be enclosed. For example, some excavators have a canopy that provides a roof but is not enclosed. A control system, shown as block 460, is provided for controlling the various work elements. Control system 460 includes operator input devices, which interact with the power system 420 to selectively provide power signals to actuators to control work functions on the excavator 400.

The swivel joint includes a bearing, a ring gear, and a slew motor with a pinion gear (not pictured) that engages the ring gear to swivel the machine. The slew motor receives a power signal from the control system 460 to rotate first or upper frame member 410 with respect to the second or lower frame member 412. First frame member 410 is capable of unlimited rotation about a swivel axis 414 under power with respect to second frame member 412 in response to manipulation of an input device by an operator. Hydraulic conduits may be fed across and/or through the swivel joint via a hydraulic swivel to provide pressurized hydraulic fluid to the tractive elements and one or more work elements such as lift arm 431 that are operably coupled to second frame member 412.

The first lift arm structure 430 is mounted to first frame member 410 via a swing mount 415. (Some excavators do not have a swing mount of the type described here.) The first lift arm structure 430 is a boom-arm lift arm of the type that is generally employed on excavators although certain features of this lift arm structure may be unique to the lift arm. The first lift arm structure 430 includes a first portion, known generally as a boom 432 and a second portion known as an arm or a dipper 434. Boom 432 is pivotally attached on a first end to mount 415. A boom actuator 433B is attached to the mount 415 and the boom 432. Actuation of the boom actuator 433B causes the boom 432 to pivot about the boom pivot mount 441, which effectively causes a second or distal end of the boom to be raised and lowered with respect to first or upper frame member 410. A first end 434A of the arm 434 is pivotally attached to the second end of the boom 432 at an arm mount pivot 434C. An arm actuator 433C is attached to boom 432 and the arm 434. Actuation of the arm actuator 433C causes the arm to pivot about the arm mount pivot 434C. Each of the swing actuator, the boom actuator 433B, and the arm actuator 433C can be independently controlled in response to control signals from operator input devices.

An exemplary implement interface 470 is provided at a second end of the arm 434. The implement interface 470 includes an implement carrier 472 that is capable of accepting and securing a variety of different implements to the lift arm 430. Such implements have a machine interface that is configured to be engaged with the implement carrier 472. The implement carrier 472 is pivotally mounted to the second end of arm 434. An implement carrier actuator 433D is operably coupled to the arm 434 and a linkage assembly 476. Linkage assembly 476 includes a first link 476A and a second link 476B. The first link 476A is pivotally mounted to arm 434 and the implement carrier actuator 433D. The second link 476B is pivotally mounted to the implement carrier 472 and the first link 476A. The linkage assembly 476 is provided to allow the implement carrier 472 to pivot about the arm 434 when the implement carrier actuator 433D is actuated.

The implement interface 470 also includes an implement power source (not shown in FIG. 6) available for connection to an implement on the lift arm structure 430. The implement power source may include a pressurized hydraulic fluid port to which an implement may be coupled. The pressurized hydraulic fluid port selectively provides pressurized hydraulic fluid for powering one or more functions or actuators on an implement. The implement power source can also include an electrical power source for powering electrical actuators and/or an electronic controller on an implement. The electrical power source can also include electrical conduits that are in communication with a data bus on excavator 400 to allow communication between a controller on an implement and electronic devices on the excavator 400.

The second frame member or lower frame 412 supports and has attached to it the pair of tractive elements, identified in FIG. 6 as left track drive assembly 440A and right track drive assembly 440B. Each of the tractive elements has a track frame 442 that is coupled to the second frame member or lower frame 412. Each track frame 442 supports and is surrounded by an endless track 444, which rotates under power to propel the excavator 400 over a support surface. Various elements are coupled to or otherwise supported by the track frame 442 for engaging and supporting the track 444 and cause it to rotate about the track frame. For example, each track frame 442 includes a motor that may be supported by the track frame 442 and engage the endless track 444 to cause the endless track to rotate about the track frame. In particular, first or left track drive assembly 440A includes a first or left track motor 482 and second or right track drive assembly 440B includes a second or right track motor 483. An idler 445 may be held against track 444 by a tensioner (not shown) to maintain proper tension on the track. The track frame 442 also may support a plurality of rollers, which engage the track and, through the track, the support surface to support and distribute the weight of the excavator 400. An upper track guide 449 may also be provided for providing tension on track 444 and prevent the track from rubbing on track frame 442.

A second, or lower lift arm 431 is pivotally attached to the second frame member or lower frame 412. A lower lift arm actuator 433A is pivotally coupled to the second frame member or lower frame 412 at a first end and to the lower lift arm 431 at a second end. The lower lift arm 431 is configured to carry a lower implement 474. The lower implement 474 may be rigidly fixed to the lower lift arm 431 such that it is integral to the lift arm. Alternatively, the lower implement 474 may be pivotally attached to the lower lift arm via an implement interface, which in some embodiments can include an implement carrier of the type described above. Lower lift arms with implement interfaces can accept and secure various types of implements thereto. Actuation of the lower lift arm actuator 433A, in response to operator input, causes the lower lift arm 431 to pivot with respect to second frame member or lower frame 412, thereby raising and lowering the lower implement 474.

First frame member or upper frame 410 supports cab 452, which defines, at least in part, operator compartment or station 450. A seat is provided within cab 452 in which an operator may be seated while operating the excavator. While sitting in the seat, an operator will have access to a plurality of operator input devices 456 that the operator can manipulate to control various work functions, such as manipulating the lift arm 430, the lower lift arm 431, the traction system, pivoting the first frame member or upper frame 410, the tractive elements 440A and 440B, and so forth. For example, hydraulic joysticks can be provided to control the lift arm 430 and swiveling of the first frame member 410. Foot pedals with attached levers are provided for controlling travel and lift arm swing. Electrical switches are located on the joysticks for controlling the providing of power to an implement attached to the implement carrier 472. Other types of operator inputs that can be used in excavator 400 and other excavators and power machines include, but are not limited to, switches, buttons, knobs, levers, variable sliders and the like. The specific control examples provided above are exemplary in nature and not intended to describe the input devices for all excavators and what they control.

Display devices are provided in the cab to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

The description of excavator 400 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on an excavator such as excavator 400 shown in FIG. 6, unless otherwise noted, the concepts discussed below are not intended to be limited in their application to the environments specifically described above.

While FIG. 6 has been generally described as a diesel-hydraulic excavator, it is to be understood that various embodiments of the present disclosure may be applicable to electric-over-hydraulic work machines and all-electric work machines. In some specific embodiments, the first and second lift arm structure may be hydraulically driven while the tractive elements may be electrically driven.

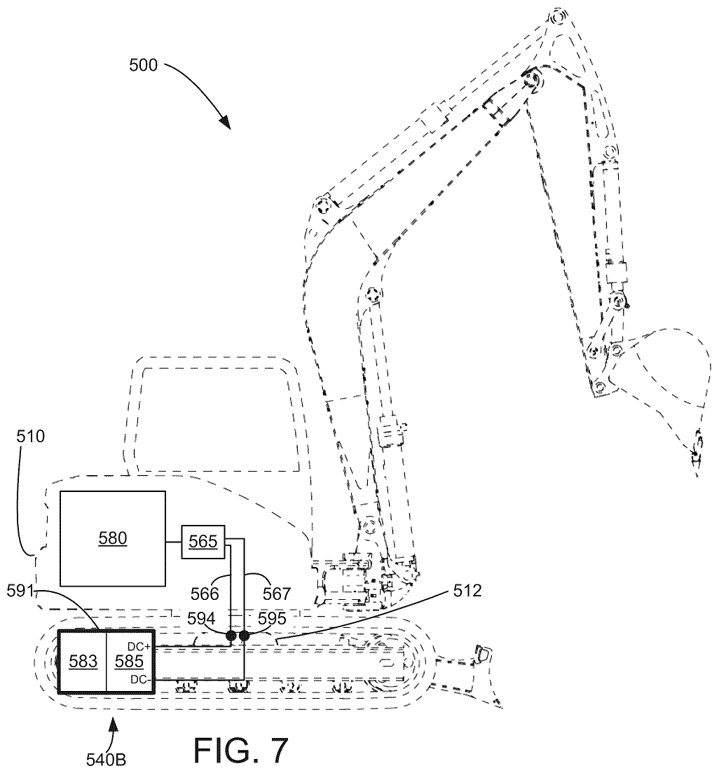

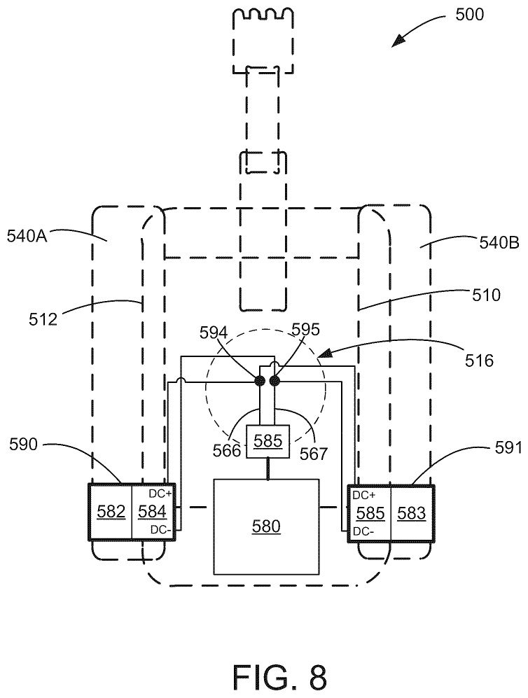

FIG. 7 illustrates a diagrammatic side view, and FIG. 8 illustrates a diagrammatic top view of an all-electric power machine in the form of an all-electric excavator 500 including battery or battery pack 580 located on and supported by first or upper frame member 510. A second or lower frame member 512 includes at least one tractive element with FIGS. 7 and 8 illustrating a first left tractive element 540A and a second right tractive element 540B, at least one electric drive motor with FIGS. 7 and 8 illustrating a first left electric drive motor 582 configured to propel tractive element 540A and a second right electric drive motor 583 configured to propel tractive element 540B, at least one inverter with FIGS. 7 and 8 illustrating a first left inverter 584 located in proximity to and electrically coupled to first left electric drive motor 582 and a second right inverter 585 located in proximity to and electrically coupled to second right electric drive motor 583. Under one embodiment, the at least one electric drive motor and the at least one inverter may be packaged together in an at least one motor package with FIGS. 7 and 8 illustrating first left electric drive motor 582 and first left inverter 584 packaged together in a first left motor package 590 and second right electric drive motor 583 and second right inverter 585 packaged together in a second right motor package 591.

All-electric excavator 500 further includes a DC distributor 565 that may be located on first or upper frame member 510 and is configured to route DC power from battery pack 580 to each of the first left inverter 584 and second right inverter 585 in the lower frame. In particular, DC distributor 565 is configured to route an electrical connection across and/or through swivel joint 516 to couple to first left and second right inverters 584 and 585 or first left motor package 590 and second right motor package 591. In such a configuration, the power source and inverters are positioned on opposite sides of the swivel joint. An electrical connection may be pathways or wires, such as a pair of high voltage pathways or wires 566 and 567, that extend from DC distributor 565 to swivel joint 516 using, for example, a slip ring, which includes rings of electrical contacts that are always touching at any point in a circle, or a rotary transformer, which transfers power “wirelessly” to the rings, and may be pathways or wires, such as a pair of high voltage pathways or wires, that extend from the slip ring or rotary transformer to a first tee connection 594 and a second tee connection 595. One of the pair of high voltage pathways or wires 566 couples to first tee connection 594 on second or lower frame member 512 and the other of the pair of high voltage pathways or wires 567 couples to second tee connection 595 on second or lower frame member 512. At first tee connection 594, high voltage pathway or wire 566 splits and couples to a DC+ terminal on first left inverter 584 or first left motor package 590 and couples to a DC+ terminal on second right inverter 585 or second right motor package 591. At second tee connection 595, high voltage pathway or wire 567 splits and couples to a DC− terminal on first left inverter 584 or first left motor package 590 and couples to a DC− terminal on second right inverter 585 or second right motor package 591.

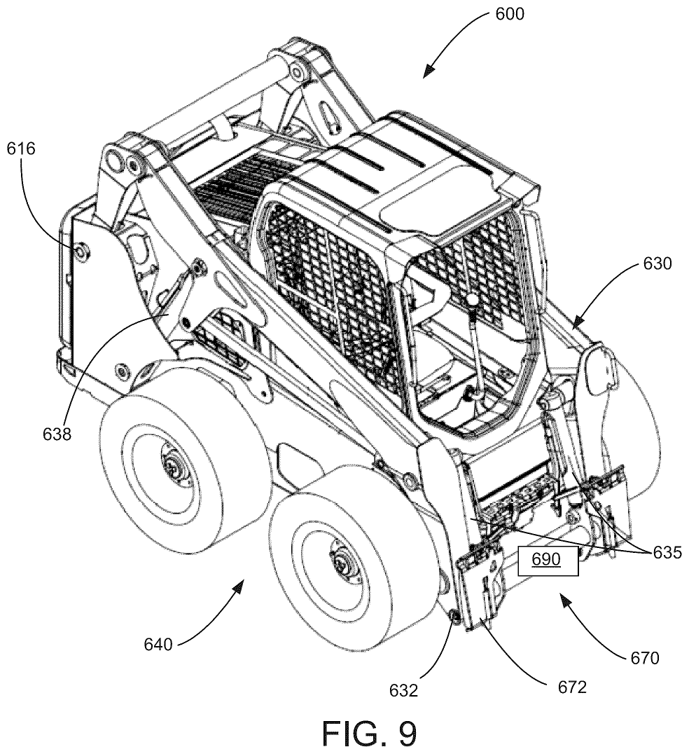

FIG. 9 is a perspective view showing generally a front of a power machine in the form of a skid-steer loader 600 on which other embodiments disclosed may be advantageously practiced. Loader 600 includes a frame that supports a power system, the power system being capable of generating or otherwise providing power for operating various functions on the power machine. In exemplary embodiments, loader 200 may be an electric loader and the power system may include battery packs and electric components such as electric motors, inverters, battery charging components, etc. In other embodiments, the power system may include an engine, such as in a hybrid-electric power system.

The frame of loader 600 supports a work element in the form of a lift arm assembly 630 that is powered by the power system and may perform various work tasks. As loader 600 is a work vehicle, the frame of loader 600 also supports a traction system 640, which is also powered by the power system and can propel the power machine over a support surface. The lift arm assembly 630 in turn supports an implement interface 670, which includes an implement carrier 672 that can receive and secure various implements to the loader 600 for performing various work tasks and at least one electric drive motor package 690, to which an implement may be coupled for selectively providing power to an implement. In some exemplary embodiments, implement interface 670 can be configured to include implement mounting and coupling features such as those described in U.S. Pat. No. 5,562,397 entitled, “Power Actuator for Attachment Plate” and issued on Oct. 8, 1996; in U.S. Pat. No. 9,631,755, entitled “Implement Interface” and issued on Apr. 25, 2017; in U.S. Pat. No. 9,885,167 entitled, “Implement Interface” and issued on Feb. 6, 2018; and in U.S. Pat. No. 11,255,070 entitled, “Hydraulic Coupling” and issued on Feb. 22, 2022. These patents are hereby incorporated by reference.

Lift arm assembly 630 is one example of many different types of lift arm assemblies that can be attached to a power machine such as loader 600 or other power machines on which embodiments of the present discussion can be practiced. The lift arm assembly 630 is what is known as a vertical lift arm, meaning that the lift arm assembly 630 is moveable (i.e., the lift arm assembly can be raised and lowered) under control of and with respect to the frame of loader 600 along a lift path that forms a generally vertical path. Other lift arm assemblies can have different geometries and can be coupled to the frame of a loader in various ways to provide lift paths that differ from the radial path of lift arm assembly 630. For example, some lift paths on other loaders provide a radial lift path. Other lift arm assemblies can have an extendable or telescoping portion. Other power machines can have a plurality of lift arm assemblies attached to their frames, with each lift arm assembly being independent of the other(s). Unless specifically stated otherwise, none of the inventive concepts set forth in this discussion are limited by the type or number of lift arm assemblies that are coupled to a particular power machine.

Lift arm assembly 630 has a pair of lift arms that are disposed on opposing sides of the frame of loader 600. A first end of each of the lift arms is pivotally coupled to the power machine at joints 616 and a second end of each of the lift arms is positioned forward of the frame when in a lowered position as shown in FIG. 9. Joints 616 are located toward a rear of the loader 600 so that the lift arms extend along the sides of the frame. The lift path is defined by the path of travel of the second end of the lift arms as the lift arm assembly 630 is moved between a minimum and maximum height.

The lift arms are each coupled to a cross member 636 that is attached to the first portions. Cross member 636 provides increased structural stability to the lift arm assembly 630. A pair of actuators 638, which on loader 600 can be electric actuators or hydraulic cylinders configured to receive power from the power system, are pivotally coupled to both the frame and the lift arms at pivotable joints, respectively, on either side of the loader 600. The actuators 638 are sometimes referred to individually and collectively as lift cylinders. Actuation (i.e., extension and retraction) of the actuators 638 cause the lift arm assembly 630 to pivot about joints 616 and thereby be raised and lowered along a fixed path.

Implement interface 670 is provided proximal to a second end of the lift arm assembly 630. The implement interface 670 includes implement carrier 672 that is capable of accepting and securing a variety of different implements to the lift arm 630. Such implements have a complementary machine interface that is configured to be engaged with the implement carrier 672. The implement carrier 672 is pivotally mounted at the second end of the lift arms. Implement carrier actuators 635 are operably coupled to the lift arm assembly 630 and the implement carrier 672 and are operable to rotate the implement carrier with respect to the lift arm assembly 630. Implement carrier actuators 635 can be electric actuators or hydraulic cylinders, depending upon the power system utilized, and are often known as tilt actuators.

By having an implement carrier capable of being attached to a plurality of different implements, changing from one implement to another can be accomplished with relative ease. For example, machines with implement carriers can provide an actuator between the implement carrier and the lift arm assembly, so that removing or attaching an implement does not involve removing or attaching an actuator from the implement or removing or attaching the implement from the lift arm assembly. The implement carrier 672 provides a mounting structure for easily attaching an implement to the lift arm (or other portion of a power machine) that a lift arm assembly without an implement carrier does not have.

Some power machines can have implements or implement like devices attached to it such as by being pinned to a lift arm with a tilt actuator also coupled directly to the implement or implement type structure. A common example of such an implement that is rotatably pinned to a lift arm is a bucket, with one or more tilt cylinders being attached to a bracket that is fixed directly onto the bucket such as by welding or with fasteners. Such a power machine does not have an implement carrier, but rather has a direct connection between a lift arm and an implement.

The implement interface 670 also includes at least one electric drive motor package 690 available for connection to an implement supported by the lift arm assembly 630. The at least one electric drive motor package 690 provides, in various embodiments, power to an implement mounted on implement carrier 672 of implement interface 670. In one exemplary embodiment the at least one electric drive motor package 690 powers a PTO output shaft that automatically connects to a PTO receiver on the attached implement.

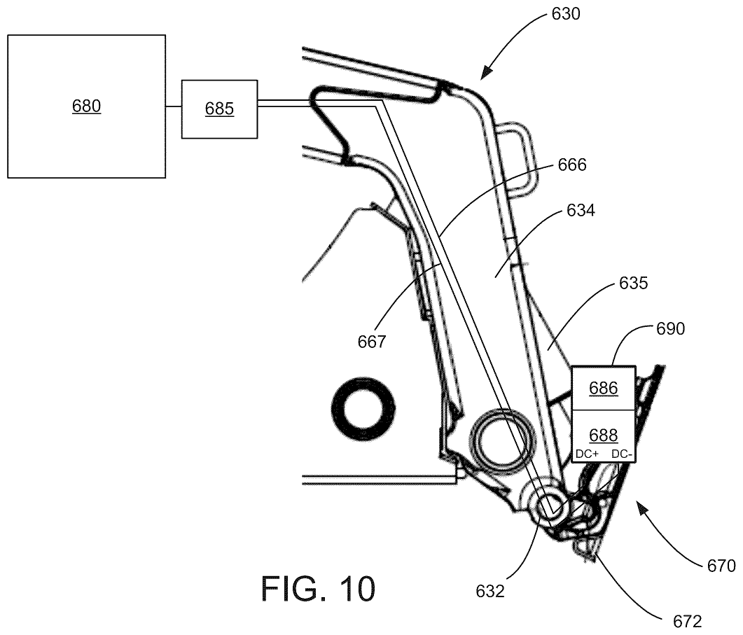

FIG. 10 is a diagrammatic side view of a power machine lift arm assembly 630 and implement carrier 672 which support components that providing power to an attached implement according to an embodiment. As shown in FIG. 10, implement carrier 672 is mounted to a lift arm 634 and is rotatable relative to the lift arm by a tilt actuator 635. A lift actuator (not shown) moves lift arm 634 relative to the power machine frame. The lift actuator and tilt actuator 635 can be electric actuators in embodiments where power machine 600 has an electric power source.

Implement interface 670 includes at least one electric drive motor package 690 that includes an electric drive motor 686 and at least one front inverter 688 located in proximity to and at least electrically coupled to electric drive motor 686. All-electric skid steer loader 600 further includes a DC distributor 665 that may be located on the main frame member of loader 600 that is configured to route DC power from battery pack 680 to inverter 688. In particular, DC distributor 665 is configured to route an electrical connection across and/or along any of the joints in lift arm assembly 630—including joint 616 that couples a first end of lift arm assembly 630 to the frame of loader 600 and joint 632 that pivotally couples implement interface 670 to a second end of lift arm assembly 630—to inverter 688 or motor package 690. An electrical connection may be a pair of high voltage pathways or wires 666 and 667. High voltage pathway or wire 666 couples to a DC+ terminal on inverter 688 or motor package 690. High voltage pathway or wire 667 couples to a DC− terminal on inverter 688 or motor package 690.

Although the subject of this disclosure has been described with reference to several embodiments, workers skilled in the art will recognize that changes may be made in form and detail without departing from the scope of the disclosure. In addition, any feature disclosed with respect to one embodiment may be included in another embodiment, and vice-versa. All references mentioned in this disclosure are hereby incorporated by reference.

What is claimed is:

1. A power machine comprising:
a first frame member;
a second frame member including at least one tractive element, at least one electric drive motor configured to propel the at least one tractive element and at least one inverter located in proximity to and coupled to the at least one electric drive motor;
a rotatable joint that rotatably couples the first frame member to the second frame member; and
at least one battery located on the first frame member and configured to power the at least one electric drive motor on the second frame member by supplying current through an electrical connection that is routed across the rotatable joint to couple to the at least one inverter.

2. The power machine of claim 1, wherein the at least one tractive element comprises a first tractive element and a second tractive element, the at least one electric drive motor comprises a first electric drive motor and a second electric drive motor and the at least one inverter comprises a first inverter and a second inverter, wherein the first electric drive motor is packaged with the first inverter into a first motor package configured to propel the first tractive element and the second electric drive motor is packaged with the second inverter into at a second motor package configured to propel the second tractive element.

3. The power machine of claim 2, wherein the electrical connection routed across the rotatable joint is split at a tee connection on the second frame member to couple to the first motor package and to couple to the second motor package.

4. The power machine of claim 1, wherein the first frame member includes at least one tractive element, at least one electric drive motor configured to operate the at least one tractive element and at least one inverter located in proximity to and coupled to the at least one electric drive motor of the first frame member.

5. The power machine of claim 1, wherein the first frame member comprises a rear frame member of an articulated loader and the second frame member comprises a front frame member of the articulated loader.

6. The power machine of claim 1, wherein the first frame member comprises an upper frame member of an excavator and the second frame member comprises a lower frame member of the excavator.

7. A power machine comprising
a front frame member including at least one front tractive element, at least one front electric drive motor configured to propel the at least one front tractive element and at least one front inverter located in proximity to and coupled to the at least one front electric drive motor;
a rear frame member including at least one rear tractive element, at least one rear electric drive motor configured to propel the at least one rear tractive element and at least one rear inverter located in proximity to and coupled to the at least one rear electric drive motor;
an articulation joint that rotatably couples the front frame member to the rear frame member; and
at least one battery located on the rear frame member and coupled to the at least one front inverter by supplying power through an electrical connection that is routed along the articulation joint to couple to the at least one front inverter.

8. The power machine of claim 7, wherein the at least one front electric drive motor and the at least one front inverter are packaged together in an at least one front motor package and wherein the at least one front motor package is configured to couple to the electrical connection routed along the articulation joint from the at least one battery.

9. The power machine of claim 8, wherein the at least one front motor package comprises a first front motor package configured to propel a first front tractive element and a second front motor package configured to propel a second front tractive element.

10. The power machine of claim 9, wherein each of the electrical connection routed along the articulation joint split at a tee connection on the front frame member to couple to terminals on the first front motor package and to couple to terminals on the second front motor package.

11. The power machine of claim 7, wherein the at least one rear electric drive motor and the at least one rear inverter are packaged together in an at least one rear motor package and wherein the at least one rear motor package is configured to couple to a second electrical connection.

12. The power machine of claim 7, where the at least one front electric drive motor and the at least one front inverter comprise a first front electric drive motor configured to propel a first front tractive element, a second front electric drive motor configured to propel a second front tractive element, a first front inverter located in proximity to and coupled to the first front electric drive motor and a second front inverter located in proximity to and coupled to the second front electric drive motor.

13. The power machine of claim 12, wherein the first front electric drive motor and the first front inverter are packaged together in a first front motor package and wherein the second front electric drive motor and the second front inverter are packaged together in a second front motor package.

14. The power machine of claim 13, wherein the electrical connection routed along the articulation joint splits at a tee terminal on the front frame member to couple to the first front motor package and to couple to the second front motor package.

15. The power machine of claim 7, where the at least one rear electric drive motor and the at least one rear inverter comprise a first rear electric drive motor configured to propel a first rear tractive element, a second rear electric drive motor configured to propel a second rear tractive element, a first rear inverter located in proximity to and coupled to the first rear electric drive motor and a second rear inverter located in proximity to and coupled to the second rear electric drive motor, wherein each of the first rear inverter and the second rear inverter are coupled to the at least one battery.

16. A power machine comprising:
an undercarriage and a house rotatably coupled to the undercarriage at a swivel joint;
a first tractive element coupled to a left side of the undercarriage and having a first electric drive motor and a first inverter located in proximity to and coupled to the first electric drive motor, wherein the first electric drive motor is configured to propel the first tractive element;
a second tractive element coupled to a right side of the undercarriage and having a second electric drive motor and a second inverter located in proximity to and coupled to the second electric drive motor, wherein the second electric drive motor is configured to propel the second tractive element; and
at least one battery located on the house and coupled to the first inverter and the second inverter by supplying power through an electrical connection that is routed through the swivel joint.

17. The power machine of claim 16, wherein the first electric drive motor of the first tractive element and the first inverter are packaged together in a first motor package.

18. The power machine of claim 16, wherein the second electric drive motor of the second tractive element and the second inverter are packaged together in a second motor package.

19. The power machine of claim 16, wherein the electrical connection that is routed through the swivel joint splits at a corresponding tee connection on the undercarriage to couple to terminals on the first inverter and to couple to terminals on the second inverter.

20. The power machine of claim 16, wherein the house is pivotally coupled to an upper lift arm structure and the undercarriage is pivotally coupled to a lower lift arm structure.
